(19) United States
(12) Patent Application Publication
(10) Pub. No.: US 2007/0106873 A1
(43) Pub. Date: May 10, 2007

(54) Apparatus and method for translating addresses

(75) Inventors: Megan A. Lally, Worcester, MA (US); John W. Edwards JR., Lake Worth, FL (US); Michael P. McGee, Woburn, MA (US)

Correspondence Address: Kirkpatrick & Lockhart Preston Gates Ellis LLP, STATE STREET FINANCIAL CENTER, One Lincoln Street, BOSTON, MA, 02111-2950, US

(73) Assignee: Stratus Technologies Bermuda Ltd., Hamilton (BM)

(21) Appl. No.: 11/267,462

(22) Filed: Nov. 4, 2005

(51) Int. Cl. G06F 12/00

(52) U.S. Cl. 711/202

(57) ABSTRACT

An apparatus and method is provided for translating addresses and rerouting them to preferably one of at least two destinations. This is accomplished through the use of a memory unit and a combination of logic operation units that essentially operate as a look-up translation table configurable by software. The apparatus includes an input to receive an address of a certain length and a memory unit that is adapted to receive a portion of the input address and output another address of a predetermined length which is mapped to the input. The method includes receiving input addresses of a certain length and performing an operation on a portion of the input address to determine its destination.

### FIELD OF THE INVENTION

The present invention relates in general to the field of computers, and, in particular, to addressing devices and memory spaces in a computer system.

### BACKGROUND OF THE INVENTION

Memory and device input/output addressing in computer systems are implemented using a variety of addressing methods which are well known and extensively used. An address may be used to designate a fundamental element of storage, the input/output of a device, or other networked components. Addressing methods and standards may be upgraded over time to reflect many changing needs. These needs may include a growing number of devices, larger memory space or simply a need for more dynamic systems to accurately and rapidly channel data and other control signals to their destinations.

When a new version of an addressing protocol is developed, a long transitional period ensues before it can be fully implemented. This period is necessary to allow for the upgrade of existing devices and other components to become compatible with the new addressing protocol. In some cases, the cost of replacing or redesigning the entire system is prohibitive.

Thus, a mechanism that allows for both older or legacy address protocol and newer versions of the addressing protocol to coexist and communicate within the same system address space is desirable. The legacy address space, which essentially belongs to the older system, continues to remain in use for the reasons enumerated above. In operation, the legacy addresses may then be translated to new addresses. Alternatively, new addresses may be translated to legacy addresses to accommodate upgraded devices within the legacy addressing space. In addition, during the transition period legacy devices may exist on one bus while new devices exist on a second bus. It is therefore important to select for which bus or destination a given address is intended. The present invention addresses these issues.

### SUMMARY OF THE INVENTION

In one aspect, the invention relates to an apparatus for translating addresses. In one embodiment, the apparatus includes an input port to receive an address of a certain length and a memory unit that is adapted to receive a portion of the input address and output another address of a predetermined length which is mapped to the input. In another embodiment, the apparatus also includes a multiplexer that is adapted to output either the input address or the address which is output by the memory unit depending on the status of a selection line. In yet another embodiment, the status of the selection line is a function of a portion of the input address. The apparatus also includes a destination select line. In still yet another embodiment, the status of the destination select line is determined by a function of a predetermined number of bits of the output from the memory unit and a certain portion of the input address.

In another aspect, the invention relates to a method of translating addresses. In one embodiment, the method includes receiving input addresses of a certain length and performing an operation on a portion of the input address to determine its destination. The method further includes the step of re-mapping input addresses of a certain length into a set of user-defined output addresses of a predetermined length. The operation performed on a portion of the input address is a logic operation to determine the destination of the address.

### BRIEF DESCRIPTION OF THE DRAWINGS

These and other aspects of this invention will be readily apparent from the detailed description below and the appended drawings, which are meant to illustrate and not to limit the invention and in which:

FIG. 1 shows a block diagram of a translation circuit constructed in accordance with one embodiment of the present invention;

FIG. 2 depicts a memory initialization table which is stored within the memory in accordance with another embodiment of the present invention; and

FIG. 3 shows a block diagram of an address translation table and its related transaction routing logic in accordance with yet another embodiment of the present invention.

### DETAILED DESCRIPTION OF AN EMBODIMENT OF THE PRESENT INVENTION

The apparatus and method for translating addresses will now be described with respect to various embodiments. In this description, like numbers refer to similar elements within various embodiments of the present invention.

Generally, the present invention provides an apparatus and method for translating addresses and routing them to one of at least two destinations. For example the translated addresses may be routed to one of two buses; one having legacy devices and the other having devices responsive to the new addressing protocol. In one embodiment, this is accomplished through the use of a memory unit and logic circuitry that essentially operates as a look-up translation table configurable by software.

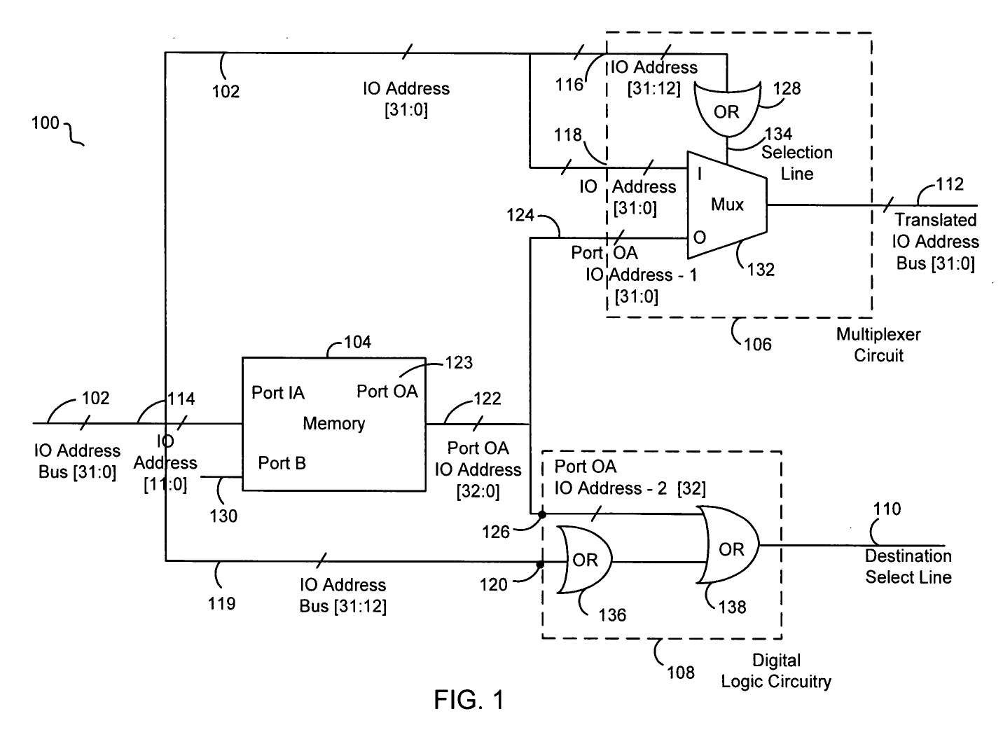

FIG. 1 shows a translation circuit 100 in accordance with one embodiment of the present invention. The translation circuit 100 includes an input IO address bus 102, a memory 104, a multiplexer circuit 106 and digital logic circuitry 108. The translation circuit 100 further includes a destination select line 110 and a translated IO address line 112 for signal output.

An IO address of predetermined length is received on the input IO address bus 102. A part of the IO address, preferably the lower order bits 114 of the input IO address bus 102, is communicated to the input port IA 103 of the memory 104. Input IO address bus 102 is also in communication with two other input ports, 116 and 118 of the multiplexer circuit 106. Finally, another logic IO address bus 119 communicates higher order bits of the input IO address bus 102 to a first input port 120 of the digital logic circuitry 108.

A portion of the memory output bus 122 from the memory 104 through memory Port OA 123 is communicated to a third input port 124 of the multiplexer circuit 106. This portion of the memory output bus 122 is designated as “Port OA address-1” and in one embodiment has the same number of bits as the original input IO address and one less bit than the output port 123 of memory 104. The remaining portion of the memory output bus 122 from Port OA 123 is designated as “Port A IO address-2” and is communicated to the second input port 126 of the digital logic circuitry 108. In one embodiment this corresponds to the highest order bit [32] of the Port OA address space.

In operation, the memory 104 receives the lower order bits 114 of the input IO address from the input IO address bus 102 and translates them, using a translation table described below, into a new address which is then the output on Port OA 123 of the memory 104. In one embodiment the lower order bits 114 of the IO address correspond to the input 102 IO address bits [11:0].

The multiplexer circuit 106 performs an operation 128 on the higher order bits of the input IO address bus 102 at its first input port 116. In various embodiments, the multiplexer circuit 106 selects either the IO address present at its second input port 118 which correspond to IO address bits [3 1:0] or the “Port OA address-1” present at its third input port 124 in response to the signal from the operation 128. Finally, the multiplexer circuit 106 places on its output port the selected address for transmission on the translated IO address bus 112.

In another embodiment, the digital logic circuitry 108 performs a combination of logic operations on the higher order bits present at its first input port 120 and “Port A address-2” present at its second input port 126. The digital logic circuitry 108 then places an output signal to the destination select line 110 in response to the logic operations.

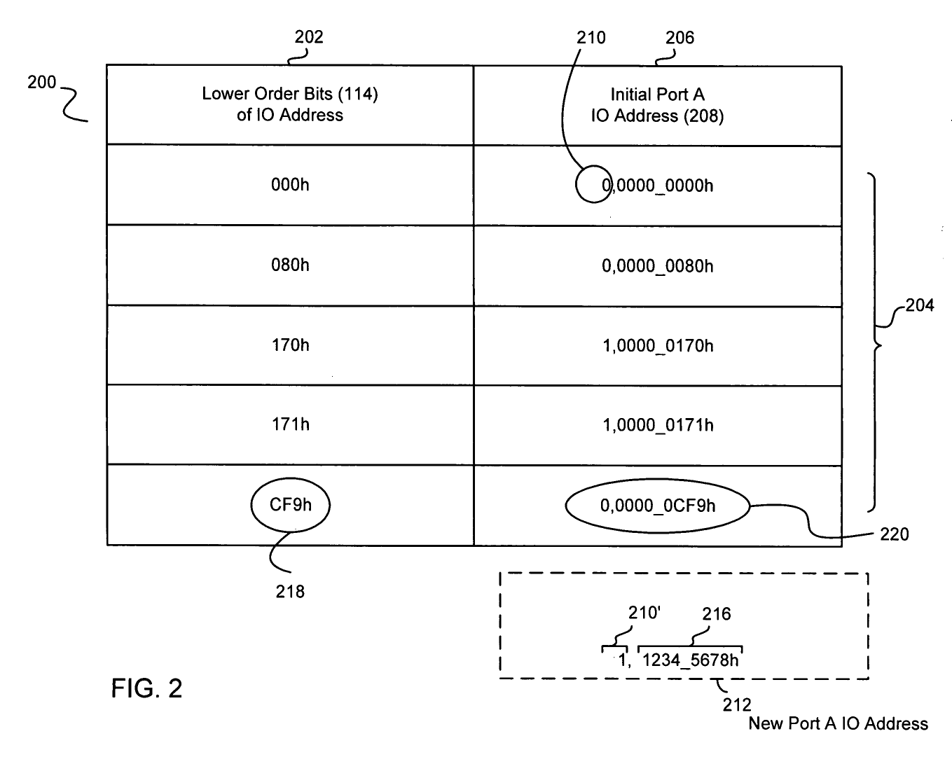

Referring also to FIG. 2, a memory initialization table 200 is depicted in accordance with another embodiment of the present invention. In this embodiment the memory initialization table 200 is stored within the memory 104. In the table 200 the first column 202 corresponds to the lower order bits [11:0] 114 of the original input IO addresses. The data in the data fields 204 of the second column 206 correspond to the initial addresses stored in data elements of the memory 104. The lower order bits [11:0] 114 of each input IO address are used to address the data fields 204 which represent the data elements of the memory 104. The data fields 204 themselves are updated by a CPU (not shown) during initialization with initial data 208, including a certain number of additional bits 210 in each data field 204 required to determine destination of the address; for example, on which bus the address is intended. These fields 204 with initial data 208 are subsequently rewritten by new addresses which are then output on Port OA 123.

Referring again to FIG. 1, the memory 104 is preferably a dual-port random access memory (RAM). After power-up, or following a reset to the IO subsystem, software in the CPU (not shown) is used to initialize the RAM with initial data 208. In this embodiment, a predetermined number of bits 210 are also concatenated to the initial data which powers-up to a hardware defined initial state. The programming of the RAM is preferably accomplished through memory writes by the CPU at memory Port B 130. In an embodiment of the present invention, first a translation address register in memory 104 is written followed by data written to a translation data register also in memory 104 (both not shown). The translation address register points to a data element in the memory 104 while the translation data register stores the data to be written at that location. There is no read-back path for the dual-port RAM since Port B 130 is designated as “write-only”.

As a hypothetical example, imagine a scenario in which the length of each IO address is 32 bits wide labeled as [31:0] as shown in FIG. 1. Referring now to FIG. 2, consider the initial data 208, written in hexadecimal notation, shown to be 32 bits long. Each hexadecimal character represents 4 bits. An additional bit 210, the initial state of which is also hardware defined, is included in this initial address 208.

When a new Port OA IO address 212 is written in a data field 204 (i.e., data element of the memory 104), an additional bit 210′ is concatenated to the actual new address 216 to designate destination of the new address. Thus, to remap the original IO address “CF9h” 218 which appears on the input IO address bus 102 to new Port A IO address “1,1234_5678h” 212, location “CF9h” which is occupied by the initial address “0,0000_OCF9h” 220, would be rewritten with new address 212. In this scenario, when the memory sees a request to address “CF9h”, it would replace the original address “CF9h” 218 with the translated address “1,1234_5678h” and the digital logic circuitry 108 sends the address 216 to the destination designated by the additional bit 210. In one embodiment, 12 bits are needed for the legacy space addressing. Eight characters of 4 bits each constitutes the new address length of 32 bits. An additional bit is necessary for routing as described above, making the translated address 33 bits long. Thus, the RAM capacity desirable for this scenario is 4k×33 bits (4k=212).

Referring again to FIG. 1, in accordance with another embodiment of the present invention, the multiplexer circuit 106 preferably includes of a multiplexer 132 and the operation circuit 128 is a multiline “OR” gate. Higher order bits of the input IO address communicated to the input port 116 of the multiplexer circuit. 106 is the input to the multiline “OR” gate 128. The “OR” gate 128 produces an output signal on selection line 134 which instructs the multiplexer 132 which address on the input ports 118 or 124 is to be output on the translated IO address bus 112.

An artisan with ordinary skill in the art will readily recognize the standard function performed by an “OR” gate. Additionally, although the multiplexer circuit 106 is described as consisting of a specific logic gate, the skilled artisan will also readily recognize that the function performed by the “OR” gate 128 in this disclosure may be alternatively performed by an equivalent or a combination of other logic gates.

As indicated above, based on the value in selection line 134, the multiplexer 132 is adapted to select one of its two inputs, the original input IO address 102 or the “Port A address-1” on the second 118 and third 124 input ports of the multiplexer circuit 106, respectively. The selected address is subsequently placed on the translated IO address bus 112.

In accordance with yet another embodiment of the present invention, the digital logic circuitry 108 includes two “OR” gates. Higher order bits [31:12] of the original IO address, at the input port 120 of the digital logic circuitry 108, are input signals to a first “OR” gate 136. “Port A address-2”, at the second input port 126 of the digital logic circuitry 108, is one input to a second “OR” gate 138 which combines with the output of the first “OR” gate 136 to produce another output that is designated as the destination select signal 110. Again an artisan skilled in the art will readily recognize that the function performed by the combination of logic gates in the digital logic circuitry 108 may be alternatively performed by an equivalent or a combination of other logic gates.

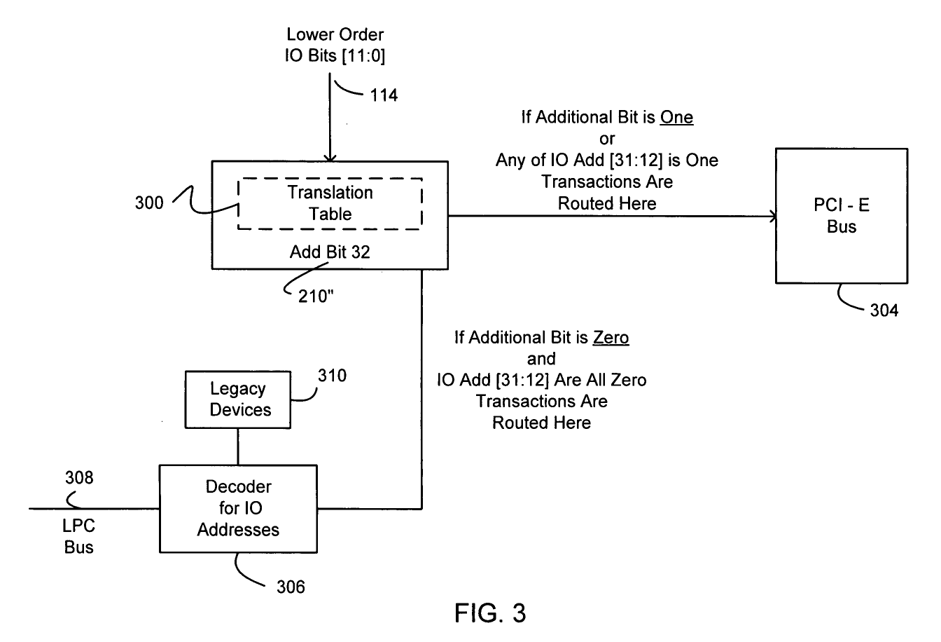

The use of this destination select line is best understood with reference to FIG. 3. A generalized address translation table 300 and its related transaction routing logic is depicted as an alternative representation of the translation circuit 100 in accordance with still yet another embodiment of the present invention. Two destinations are depicted for the purpose of this embodiment which are selected by the status of the additional bit 210″ described in FIG. 2 and the higher order bits 120 described in FIG. 1. The first destination is the standard PCI-Express bus 304 and the second is a decoder circuit 306 which uses legacy addressing to select a Low Pin Count (LPC) bus 308 or one of two or more legacy devices 310.

The input signals to the translation table 300 are preferably the lower order bits 114 of the original input IO address. The translation table 300 then performs the conversion of addresses to new addresses and concatenates an additional bit 210″. The additional bit 302 is used to designate the destination of the translated address. The additional bit 210″ is concatenated during the initialization period of the RAM. If the value of the additional bit is 1, the destination of the address is the PCI Express bus 304, otherwise the destination is the decoder circuit 306 and then the LPC bus 308 or a legacy device 310.

Those skilled in the art will recognize the many benefits and advantages afforded by the present invention. The invention enables the translation of addresses and also includes the additional ability to reroute them to one of at least two destinations.

While the invention has been particularly shown and described with references to the preferred embodiments thereof, it will be understood by those skilled in the art that various changes in form and detail may be made therein without departing from the spirit and scope of the invention.

What is claimed is:

1. An apparatus for translating addresses comprising:
an input bus to receive an input address of predetermined length;
a memory, in communication with the input bus, adapted to receive a first portion of the input address and to output an address of predetermined length mapped to the first portion of the input address; and
a multiplexer, in communication with the input bus and the memory, adapted to output either the input address or the output of the memory based on the status of a selection line;
wherein the status of the selection line is in response to a first operation on a second portion of the input address.

2. The apparatus of claim 1 further comprising a destination select line, in communication with the memory and the input bus, wherein the status of the destination select line is in response to a second operation on a predetermined number of bits of the output from the memory and the second portion of the input address.

3. The apparatus of claim 2 wherein the first and second operations are logical ‘OR’ operations.

4. The apparatus of claim 1 wherein the first portion of the input address received at the memory comprises lower order bits.

5. The apparatus of claim 1 wherein the second portion of the input address used to determine the status of the selection line comprises higher order bits.

6. The apparatus of claim 5 wherein each address comprises 32 bits conforming to an address encoding standard.

7. The apparatus of claim 1 wherein the memory is further configured to concatenate a predetermined number of additional bits to the output address.

8. The apparatus of claim 1 wherein the predetermined number of additional bits equals one additional bit.

9. The apparatus of claim 8 wherein the additional bit of the output address from the memory is combined with the second portion of the input address to determine the status of the destination select line.

10. A method of translating addresses, comprising the steps of:
receiving an input address of predetermined length;
performing a table look-up based on a first portion of the input address;
producing a new address of predetermined length in response to the first portion of the input address;
selecting for transmission either the input address or a first portion of the new address based on a second portion of the input address; and
determining the destination of the input address or first portion of the new address in response to a second portion of the input address and a second portion of the new address.

11. The method of claim 10 wherein the step of performing a table look-up based on a first portion of the input address use a preloaded look-up table.

12. The method of claim 10 wherein the step of determining the destination of the input address or first portion of the new address comprises: performing a first logic on the second portion of the input address.

13. The method of claim 12 wherein the step of determining the destination of the input address or first portion of the new address further comprises: performing a second logic operation on the output of the first logic operation and the second portion of the new address.

14. The method of claim 13 wherein the first and second logic operations include one or more operations selected from a group consisting of OR, AND, NOT, NAND, NOR and XOR operations.

15. The method of claim 13 wherein the first and second logic operations are ‘OR’ operations.

16. The method of claim 13 further comprising the step of designating the output of the second logic operation as a destination select signal.
